(19) United States
(12) Patent Application Publication
(10) Pub. No.: US 2007/0184899 A1
(43) Pub. Date: Aug. 9, 2007

(54) Gaming device, method, and computer program product for modifying input to a native application to present modified output

(75) Inventor: Olli Rantapuska, Vantaa (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/347,130

(22) Filed: Feb. 3, 2006

(51) Int. Cl. A63F 9/24

(52) U.S. Cl. 463/30

(57) ABSTRACT

A system, game server, terminal, and method incorporate the native applications of a gaming device into the gaming application, thereby creating immersion games that are linked with the user's daily life. Instead of starting the game to play and stopping the game when done playing, the game can run on the gaming device in the background and become a part of the user's day-to-day activities. As the gaming application is executing in the background, the gaming application detects the activation of a native application. The gaming application then generates a modified input to the native application, such that the modified input causes the native application to present a modified output to the user via an output element. The modified input may be generated by modifying or replacing the standard input from a native device to the native application. The modified input corresponds to the gaming application executing on the gaming device.

### FIELD OF THE INVENTION

Exemplary embodiments of the invention generally relate to gaming devices and methods of operating an electronic gaming device and, more particularly, relate to gaming devices, methods, and computer program products for presenting modified output.

### BACKGROUND OF THE INVENTION

Playing electronic games is a popular pastime, and continues to grow in popularity as more devices, particularly mobile devices, are created to facilitate gaming. Many mobile devices, such as mobile (e.g., cellular) telephones and personal digital assistants (PDAs), are capable of executing gaming applications. Additionally, dedicated mobile gaming devices have been created. These mobile gaming devices allow users to participate in electronic games away from the user's personal computer. When the mobile gaming devices are connected via a wireless network, the user is able to participate in multi-player electronic games away from the user's personal computer and wired network connection.

For purposes of this application, the term “gaming device” will be used to refer to all devices capable of executing gaming applications, whether the device is a personal computer, a cellular telephone, a PDA, a gaming console, a dedicated mobile gaming device, or any other type of device, whether multi-player or single player, whether connected to a network or not, and if connected to a network, whether the network is the Internet, a cellular telephone network, a proximity network (e.g., Bluetooth), or any other type of network, and whether the communication with the network is wired or wireless.

Gaming applications that run on gaming devices generally rely on the input mechanisms (or elements) of the device to let the user control the game. The input mechanism of the device will typically vary depending on the type of device. For example, if the gaming device is mobile telephone, the input mechanism is often a typical telephone keypad. Users can press keys to perform actions in the game. The gaming device will also have one or more output mechanisms (or elements) to relay game information to the user. The output mechanism of the device will also typically vary depending on the type of device, although most gaming devices will have some type of display screen (e.g., liquid crystal display) to display video images. Most gaming devices will also have an audio output mechanism, such as a speaker (also termed a loudspeaker).

Some gaming devices, especially mobile gaming devices such as mobile telephones and PDAs, have the ability to execute many different applications (which may be termed native applications), in addition to gaming applications, in order to provide additional functionality that may be desired by the user. For example, many mobile gaming devices provide communication functionality by executing a mobile telephony application, a text messaging application, or a push-to-talk communication application. Additionally, mobile gaming devices may provide audio/visual functionality by executing applications such as a video viewfinder application, a digital camera and/or camcorder application, an audio recorder and/or audio player application, a video player application, and a radio receiver (e.g., FM or satellite) application. Further, mobile gaming devices may execute a thermometer application, a global positioning system locator application, a clock application, a decibel meter application, a barometer application, an altimeter application, a movement sensor application, a light sensor application, a compass application, and many other different applications. Many of these native applications interface with an output element to present an output to the user of the device. The type and format of such an output, as well as the specific output element, will depend on the type of native application producing the output. The output may be video displayed on a display screen or audio emitted via an audio speaker. The output may be a current temperature or a map of the user's current location displayed on a display screen. In addition to the output element, these native applications are often coupled with a native input element or device, such that the native device may provide information/data from outside the gaming device to the native application that is then used by the native application to generate and present some output to the user. For example, a digital camera application would be coupled to a digital camera device that is typically housed within the gaming device. The camera device typically provides image data to the camera application, such that the camera application may display the image on a display element or save the image to a memory element. Similarly, the thermometer application would be coupled to a digital thermometer device that would provide temperature data to the thermometer application, such that the thermometer application may display current or recent temperatures on a display element. The native applications may also be coupled to a user input element, such as a keyboard or keypad. The user may initiate a native application using the user input element. The user may also use the user input element to select optional features or input data to be used by the native application while the native application is executing.

Typical gaming applications enable a user to play an electronic game during discrete periods of time. Typically, the user decides to begin playing a desired game and thus starts the game. The user then plays the game for a period of time. Finally, the user stops playing and turns the game off when the user no longer wants to play the game. However, some gaming devices enable gaming applications to run in the background and become part of the user's day-to-day life. Such gaming applications may be termed “immersion games.” One such gaming device is capable of placing telephone calls and sending text messages to the user via communication elements within the device. The calls and messages can originate from within the gaming device although appearing as if originating from someone else on the mobile network. Such a gaming device is described in International Publication No. WO 2004/040847, Method and Device for Simulating a Communication on a Terminal Device, published May 13, 2004, the contents of which are incorporated herein in its entirety.

### BRIEF SUMMARY OF THE INVENTION

A system, game server, terminal, and method are provided that incorporate the native applications of a gaming device into the gaming application, thereby creating immersion games that are linked with the user's daily life. Instead of starting the game to play and stopping the game when done playing, the game can run on the gaming device in the background and become a part of the user's day-to-day activities. As the gaming application is executing in the background, the gaming application detects the activation of a native application. The gaming application then generates a modified input to the native application, such that the modified input causes the native application to present a modified output to the user via an output element. The modified input may be generated by modifying or replacing the standard input from a native device to the native application. The modified input corresponds to a gaming application executing on the gaming device.

In one exemplary embodiment, a gaming device comprises a processing element capable of detecting an activation of a native application. The processing element may be further capable of generating a modified input to the native application, such that the modified input causes the native application to present a modified output via a user interface of the native application. The native application may be selected from the group that includes, but is not limited to, video viewfinder, digital camera, digital camcorder, audio recorder, audio player, video player, thermometer, global positioning system locator, radio receiver, mobile telephone, text messaging, push-to-talk communication, clock, decibel meter, barometer, altimeter, movement sensor, light sensor, compass and any other suitable native application. The processing element may generate the modified input by one of modifying or replacing a standard input from a native device to the native application.

In one embodiment, the native application is activated by a user of the gaming device. The user may activate the native application via a user input element. Alternatively or in addition, the native application may be activated by an event internal to the gaming device.

The gaming device may comprise an output element selected from the group consisting of audio speaker and video display, wherein the modified output is presented via the output element.

In addition to the gaming device for modifying input to a native application to present modified output described above, other aspects of embodiments of the invention are directed to corresponding methods and computer program products for modifying input to a native application to present modified output on a gaming device.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of an entity capable of operating as a gaming device, in accordance with embodiments of the invention;

FIG. 2 is a flowchart of the operation of presenting modified output on a gaming device, in accordance with an exemplary embodiment of the invention;

FIG. 3 is a schematic block diagram of an entity capable of operating as a gaming device, in accordance with alternative embodiments of the invention;

FIG. 4 is a flowchart of the operation of presenting modified output on a gaming device, in accordance with an alternative exemplary embodiment of the invention; and

FIGS. 5A-5C illustrate the presentation of modified output on a gaming device, in accordance with embodiments of the invention.

### DETAILED DESCRIPTION OF THE INVENTION

Exemplary embodiments of the invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

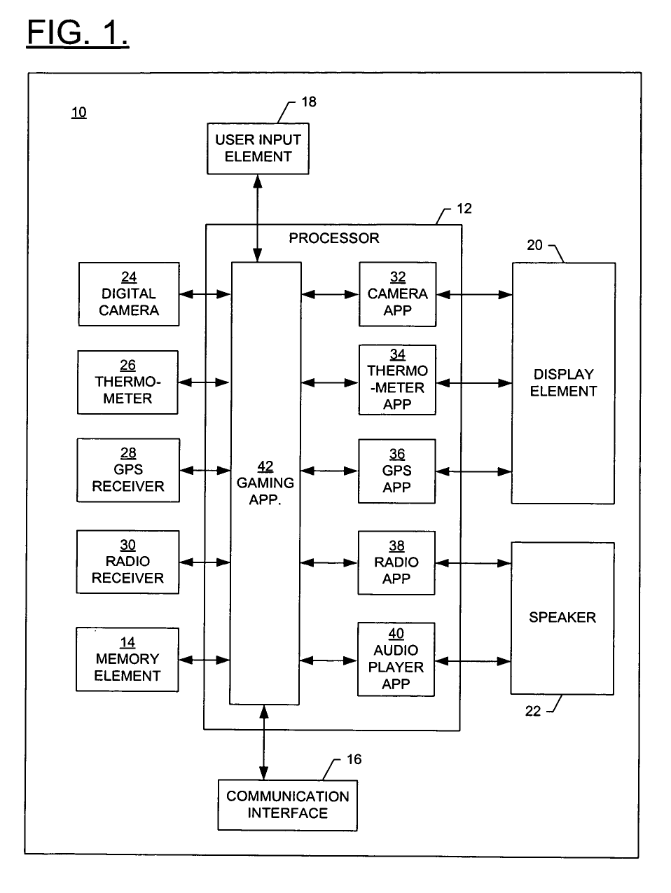

Referring now to FIG. 1, a block diagram of an entity capable of operating as a gaming device is shown, in accordance with one embodiment of the invention. The gaming device 10 of FIG. 1 may be any device capable of executing electronic gaming applications, whether the device is a personal computer, a mobile telephone, a PDA, a gaming console, a dedicated mobile gaming device, or any other type of device. As shown, the entity capable of operating as a gaming device 10 generally includes a processor 12 capable of executing a gaming application 42. While the processor can be configured in various manners, the processor may be comprised of a microprocessor, controller, dedicated or general purpose electronic circuitry, a suitably programmed computing device, or other means for executing a gaming application.

Processor 12 may be connected to or otherwise capable of accessing a memory 14. The memory can comprise volatile and/or non-volatile memory or other storage means, and typically stores content, applications, data, or the like. For example, the memory typically stores content transmitted from, and/or received by, the gaming device. Also for example, the memory typically stores native applications, instructions or the like for the processor to perform steps associated with operation of the gaming device in accordance with exemplary embodiments of the invention. As explained below, the memory can store native application(s) including a configuration utility, content manager and/or display manager. In this regard, when executed, the configuration utility may function to configure a source of content to receive or otherwise provide content. The content manager, when executed, may function to manage the receipt of content from the source, and/or the use of content received from the source. And the display manager may function to manage presentation of content received from the source. As described herein, the native application(s) each comprise software operated by the gaming device. It should be understood, however, that any one or more of the native applications described herein can alternatively comprise firmware or hardware, without departing from the spirit and scope of the invention. Moreover, while described as separate applications, one or more of these applications may be integrated into a single application.

In addition to the memory 14, the processor 12 may also be connected to at least one interface or other means for transmitting and/or receiving data, content or the like. In this regard, the interface(s) can include at least one communication interface 16 or other means for transmitting and/or receiving data. The communication interface 16 may communicate with and receive data from external devices using any known communication technique, whether wired or wireless, including but not limited to serial, universal serial bus (USB), Ethernet, Bluetooth, wireless Ethernet (i.e., WiFi), cellular, infrared, and general packet radio service (GPRS).

The processor may also be connected to at least one user interface that may include a display 20, a speaker 22, and/or a user input interface 18. The user input interface, in turn, may comprise any of a number of devices allowing the gaming device to receive data and/or commands from a user, such as a keypad, a touch display, a joystick or other input device. The user input interface may also comprise a microphone, especially if the gaming device is a mobile telephone.

The processor 12 may also be capable of executing applications other than gaming applications, such as other native applications, depending on the specific device used as the gaming device 10. For example, if gaming device 10 is a PDA, processor 12 may be capable of executing personal organization applications, such as scheduling, calendar, and address book applications. If gaming device 10 is a mobile telephone, processor 12 may be capable of executing communication applications (not illustrated in FIG. 1), such as telephony, email, or text messaging applications. As illustrated in FIG. 1, processor 12 may be capable of executing native applications such as a camera application 32, a thermometer application 34, a global positioning system (GPS) application 36, a radio application 38, and an audio player application 40.

As described above, these native applications are often coupled with a native device to obtain information/data from outside the gaming device that may be used by the native application to generate and present output to the user. The information/data sent from the native device to the native application may be termed “input” to the native application. The digital camera application 32 may be coupled to a digital camera device 24 to obtain image data. The thermometer application 34 may be coupled to a digital thermometer device 26 to obtain temperature data. The GPS application 36 may be coupled to a GPS receiver 28 to obtain position data. The radio application 38 may be coupled to a radio receiver 30 to obtain received broadcast signals, such as news or music. The radio receiver 30 may be, for example, an FM radio receiver or a satellite radio receiver. The audio player 40 may be coupled to memory element 14 in which audio files (e.g., MP3 or WAV) may be stored. Although not illustrated in FIG. 1, many of the native applications executing in the processor will have access to the memory element 14 to store and retrieve data. Although also not illustrated in FIG. 1, many of the native applications may also be coupled to the user input element 18, which may be a keyboard or keypad.

Many of the native applications interface with an output element to present an output to the user of the device (although this interface is not directly illustrated in FIG. 1). The gaming device 10 of the illustrated embodiment includes two output elements-a display element 20 and a speaker 22. The display element 20 may be used by the camera application 32 to display camera images (i.e., photographs), by the thermometer application 34 to display the current temperature, or by the GPS application 36 to display the current geographic location (such as on a map or using coordinates) of the gaming device. The speaker 22 may be used by the radio application 38 to emit a received radio broadcast or by the audio player application 40 to emit a stored audio file.

In exemplary embodiments of the invention, the gaming application 42 is capable of augmenting or distorting the user's reality by post-processing (i.e., modifying) input data that is produced by one or more of the native devices of the mobile device components and then providing the modified input data to the appropriate native application. By enabling the gaming application to have access to other native applications and native devices on the gaming device, the gaming application can surprise the user by adding game elements to the output that is generated by the native application and presented to the user. With permission, the gaming application can intercept the standard input from a native device that would normally go directly from the native device to the appropriate native application. The gaming application may then generate a modified input by either modifying or replacing the standard input, and provide the modified input to the appropriate native application. The native application would then use the modified input to generate output that is sent to an output element for presentation to the user. The native application would typically not be aware that the received input has been modified by the gaming application. As such, the gaming application is capable of causing game-related information be presented to the user via a modified output from the native application.

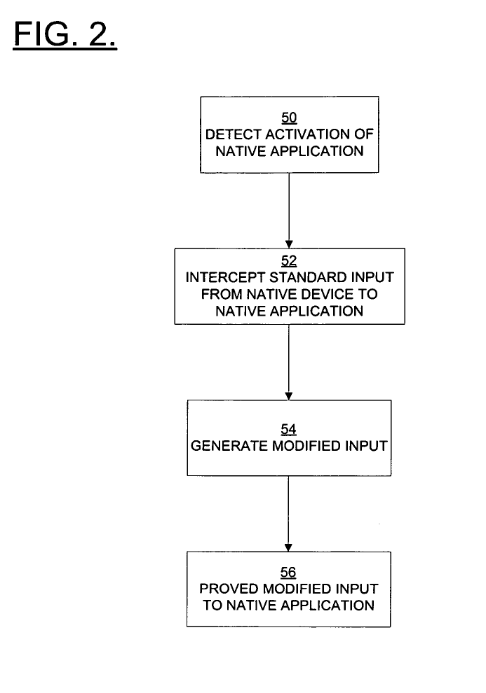

Referring now to FIG. 2, a flowchart of the operation of presenting modified output on a gaming device is illustrated, in accordance with one exemplary embodiment of the invention. The gaming application 42 would typically be executing in the background, such that the user is not actively playing the game and may not even be aware or recall that the gaming application is executing. As the user is going about the user's daily activities, the user may be carrying the gaming device while the gaming application is executing in the background. The user may decide, for reasons not related to the gaming application, to activate one of the native applications that reside on the gaming device. For example, the user may activate the camera application to take a photograph of a friend. Or the user may activate the radio application to listen to music. The gaming application can detect the activation of the native application. See block 50. The native application will typically activate a corresponding native device, and the native device will typically generate an input that is provided to the native application. This input may be termed the standard (i.e., unmodified) input of the native application. The gaming application may then intercept the standard input before the standard input is provided to the native application. See block 52. It should be appreciated that the gaming application may not necessarily intercept the standard input in all circumstances. The gaming application may consider many factors to determine whether to intercept the standard input from a particular native device at a particular time. For example, the gaming application may consider the recent sequence of other events in the game or the current status of the game story, such that the user would be presented with modified information/data that corresponds to the recent and/or current events in the game story. The gaming application may consider how recently the standard input was previously intercepted, to limit how often that modified information (based on modified input) is presented to the user. This may be accomplished by keeping track of how much time has elapsed since the previous modification of a standard input, and waiting at least a predefined amount of time before a subsequent modification of a standard input. The gaming application may randomly intercept or not intercept the standard input.

If the gaming application does not intercept the standard input, the standard input will then be used by the native application to generate a standard output which is presented normally to the user. If, based on the factors considered, the gaming application intercepts the standard input, the gaming application will then generate a modified input. See block 54. As discussed above, gaming application may generate the modified input by modifying or replacing the standard input. The gaming application may consider many factors to determine how the standard input is to be modified or what is to be presented if the standard input is to be replaced. Various possible gaming applications, using embodiments of the invention, will be described below to illustrate some of the various ways that the standard input may be modified or replaced by the gaming application to generate a modified input. After the gaming application generates the modified input, the modified input is then provided to the native application. See block 56. The native application then uses the modified input to generate output that is presented to the user via the appropriate output element (e.g., the display 20 or the speaker 22). As discussed above, the native application will typically not be aware that a modified input has be provided in place of a standard (unmodified) input. Although the user could be so notified, the user is generally not informed, at least not in advance, that the standard input has been modified or replaced by the gaming application. As discussed above, the user may then be surprised because the gaming application 42 has caused modified information to be presented to the user that the user was not expecting to see.

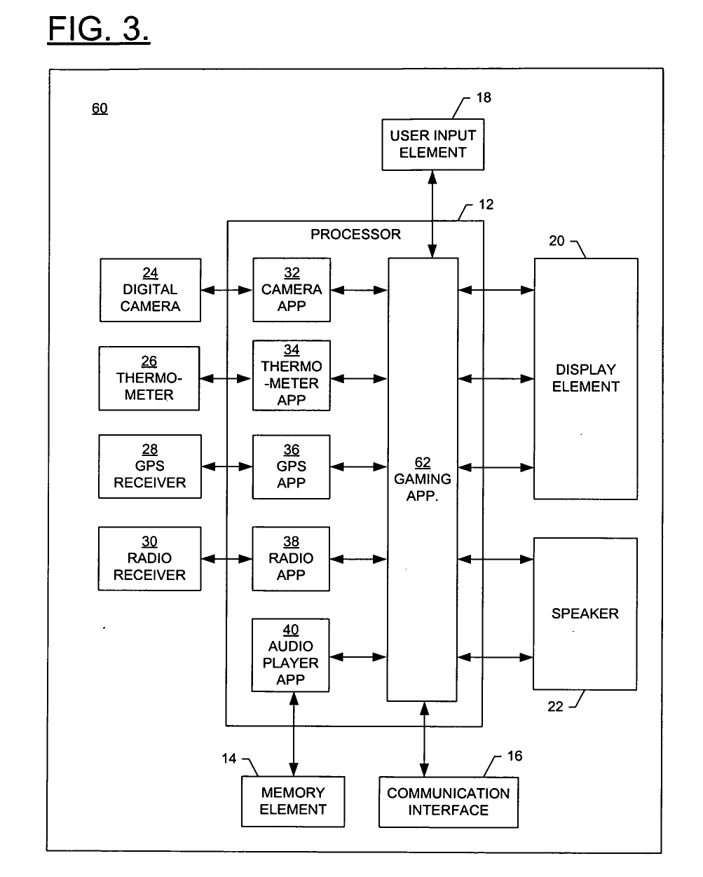

Referring now to FIG. 3, a block diagram of an entity capable of operating as a gaming device is shown, in accordance with an alternative embodiment of the invention. The gaming device 60 of FIG. 3 is similar to the gaming device 10 of FIG. 1. However, in the gaming device 60 of FIG. 3, the standard input from the native device to the native application is not intercepted and is not modified. Rather, the gaming application 62 of the gaming device 60 intercepts the standard output from the native application and modifies the output. The gaming application 62 then presents the modified output to the user via an output element. In the alternative exemplary embodiment illustrated in FIG. 3, the gaming application 62 is capable of augmenting or distorting the user's reality by post-processing output data that is produced by one or more of the native applications of the mobile device components. By enabling the gaming application to have access to other native applications on the gaming device, the gaming application can surprise the user by adding game elements to the output generated by the native application and presenting the modified output to the user. This modified output may comprise a modification of the standard output generated by a native application, or may comprise a replacement of the standard output. With permission, the gaming application can intercept the standard output from a native application that would normally go directly from the native application to the appropriate output element for presentation to the user. As such, the gaming application can modify or replace the standard output to present game-related information to the user.

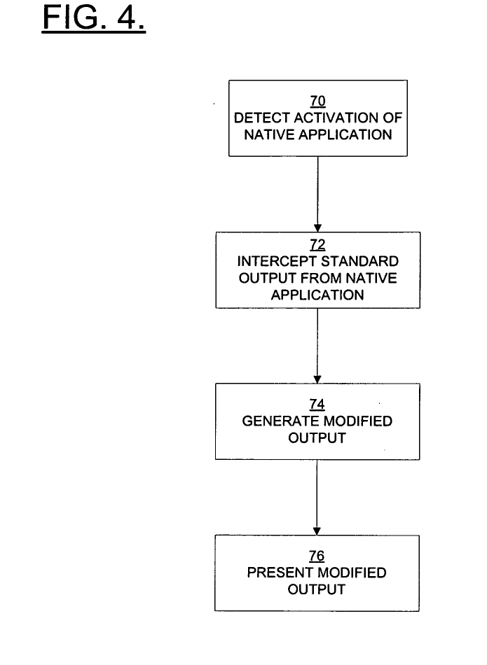

Referring now to FIG. 4, a flowchart of the operation of presenting modified output on a gaming device is illustrated, in accordance with the alternative exemplary embodiment illustrated in FIG. 3. The gaming application 62 would typically be executing in the background, such that the user is not actively playing the game and may not even be aware or recall that the gaming application is executing. As the user is going about the user's daily activities, the user may be carrying the gaming device while the gaming application is executing in the background. The user may decide, for reasons not related to the gaming application, to activate one of the native applications that reside on the gaming device. For example, the user may activate the camera application to take a photograph of a friend. Or the user may activate the radio application to listen to music. The gaming application can detect the activation of the native application. See block 70. The native application will generate an output to be presented to the user, with the output and output element depending on the specific native application that has been activated as discussed above. This output may be termed the standard (i.e., unmodified) output of the native application. The gaming application may then intercept the standard output before the standard output is presented to the user via an output element. See block 72. It should be appreciated that the gaming application may not necessarily intercept the standard output in all circumstances. The gaming application may consider many factors to determine whether to intercept the standard output from a particular native application at a particular time. For example, the gaming application may consider the recent sequence of other events in the game or the current status of the game story, such that the user would be presented with modified output that corresponds to the recent and/or current events in the game story. The gaming application may consider how recently the standard output was previously intercepted, to limit how often that modified output is presented to the user. This may be accomplished by keeping track of how much time has elapsed since the previous presentation of modified output, and waiting at least a predefined amount of time before a subsequent presentation of modified output. The gaming application may randomly intercept or not intercept the standard output.

If the gaming application does not intercept the standard output, the standard output will then be presented normally to the user. If, based on the factors considered, the gaming application intercepts the standard output, the gaming application will then generate a modified output. See block 74. As discussed above, gaming application may generate the modified output by modifying or replacing the standard output. The gaming application may consider many factors to determine how the standard output is to be modified or what is to be presented if the standard output is to be replaced. After the gaming application generates the modified output, the modified output is then presented to the user via the appropriate output element (e.g., the display 20 or the speaker 22). See block 76. Although the user could be so notified, the user is generally not informed, at least not in advance, that the standard output has been modified or replaced by the gaming application. As discussed above, the user may then be surprised because the gaming application 62 has presented a modified output to the user that the user was not expecting to see.

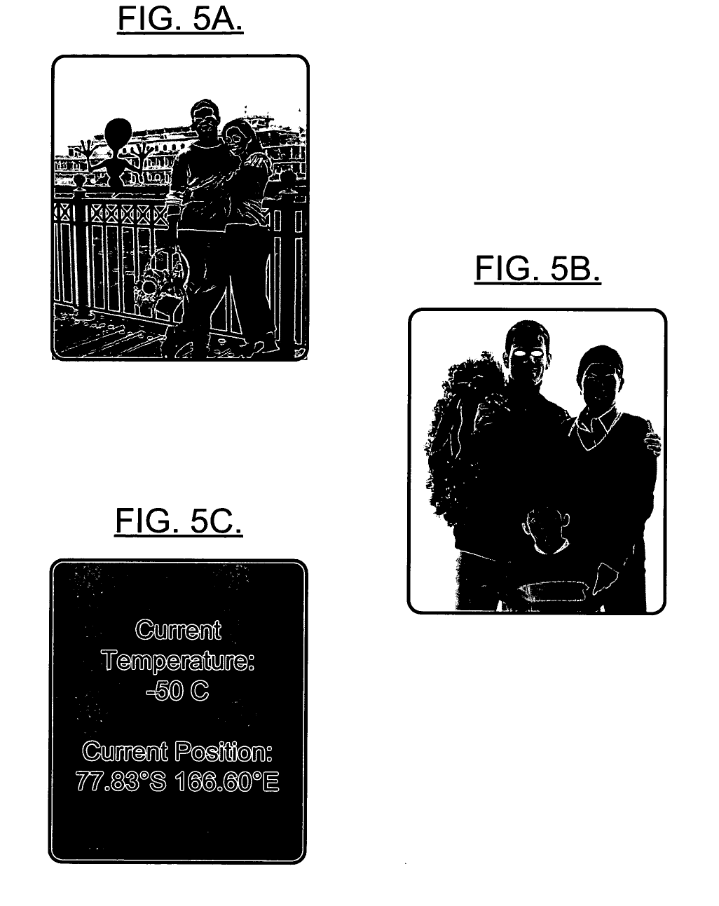

In one possible gaming application that uses embodiments of the invention, the game story involves encounter with aliens on Earth but that are invisible to humans. Using the gaming device, however, the user can search for aliens and try to discover their hidden base. The gaming application, while executing in the background, may detect when user is viewing through the camera viewfinder in the gaming device. The gaming application may at times (e.g., randomly) intercept the camera viewfinder image before the image is provided to the camera application and modify the image. The gaming application may add faint silhouettes of alien characters to the camera image in real time. The user may keep the camera viewfinder active and pan around, and possibly see a semitransparent alien character. FIG. 5A illustrates a modified output generated by a camera application using modified input. The gaming application could cause such added images to only temporarily appear on the display. By clicking the trigger and taking a picture, the user may be able to store the picture of the humanoid character.

In another possible gaming application that uses embodiments of the invention, the game story involves invisible parasites that infect people's minds. The gaming application, while executing in the background, may detect when the user is taking a photograph using the camera application in the gaming device. The gaming application may at times (e.g., randomly) intercept the photograph before the photograph is provided to the camera application and modify the photograph. The gaming application may modify the photograph to make the eyes of the person in the photograph glow blue if the person is infected. The gaming application may add glowing eyes to some of the people in some of the photographs taken by the user. FIG. 5B illustrates a modified output generated by a camera application using modified input.

In another possible gaming application that uses embodiments of the invention, the game story involves the user being teleported to random locations across the world. The gaming application, while executing in the background, may detect when the user is checking the gaming device's thermometer application, or when the user checks the current geographic position using the gaming devices GPS application. The gaming application may intercept the standard temperature or location input and replace the standard input with a modified input. The native application would then use the modified input to generate an output (that includes the modified input data) to be presented to the user. For example, the gaming application could cause a modified map showing the user's location as Antarctica and a modified temperature display of minus 50 degrees C. to be presented to the user. The gaming application has overridden the sensor information to present the game's alternate reality. FIG. 5C illustrates a modified output generated by a GPS and thermometer application using modified input.

In another possible gaming application that uses embodiments of the invention, the game story indicates that high-pitched screams signal the approach of large flying monsters. The gaming application, while executing in the background, may detect when the user activates the FM radio receiver application in the gaming device. The gaming application may intercept the standard received radio broadcast and modify the audio to add high-pitched screams in the background of the audio to indicate the presence of the dangerous monsters.

In another possible gaming application that uses embodiments of the invention, the gaming application, while executing in the background, may detect when the user activates the keypad or keyboard and begins typing. Rather than displaying the text that the user is actually typing, the gaming application may cause the display of modified text that provides clues to a mystery to be solved by the user.

It should be appreciated that there may be situations or times when the user may wish to temporarily prevent any modification of the standard input to the native applications. For example, if the user's gaming device is a PDA that is used in performing the user's occupation, the user may wish to prevent modifications during the workday. As such, the gaming application may include a “suspend” feature that can temporarily prevent the presentation of a modified information to the user.

The method for presenting modified output on a gaming device may be embodied by a computer program product. The computer program product includes a computer-readable storage medium, such as the non-volatile storage medium, and computer-readable program code portions, such as a series of computer instructions, embodied in the computer-readable storage medium. Typically, the computer program is stored by a memory device, such as memory 14, and executed by an associated processing unit, such as the processor 12.

In this regard, FIGS. 2 and 4 are flowcharts of methods and program products according to the invention. It will be understood that each step of the flowcharts, and combinations of steps in the flowcharts, can be implemented by computer program instructions. These computer program instructions may be loaded onto a computer or other programmable apparatus to produce a machine, such that the instructions which execute on the computer or other programmable apparatus create means for implementing the functions specified in the flowchart step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart step(s).

Accordingly, steps of the flowcharts support combinations of means for performing the specified functions, combinations of steps for performing the specified functions and program instruction means for performing the specified functions. It will also be understood that each step of the flowcharts, and combinations of steps in the flowcharts, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A gaming device for modifying input to a native application to present modified output, the gaming device comprising:
a processing element capable of detecting an activation of a native application and generating a modified input to the native application, the modified input corresponding to a gaming application executing on the gaming device, such that the modified input causes the native application to present a modified output via a user interface of the native application.

2. The gaming device of claim 1, wherein the native application is selected from the group consisting of video viewfinder, digital camera, digital camcorder, audio recorder, audio player, video player, thermometer, global positioning system locator, radio receiver, mobile telephone, text messaging, push-to-talk communication, clock, decibel meter, barometer, altimeter, movement sensor, light sensor, and compass.

3. The gaming device of claim 1, wherein processing element generates the modifed input by one of modifying or replacing a standard input from a native device to the native application.

4. The gaming device of claim 1, wherein the native application is activated by a user of the gaming device.

5. The gaming device of claim 4, further comprising:
a user input element, wherein the user activates the native application via the user input element.

6. The gaming device of claim 1, wherein the native application is activated by an event internal to the gaming device.

7. The gaming device of claim 1, further comprising:
an output element selected from the group consisting of audio speaker and video display, wherein the modified output is presented via the output element.

8. A method for modifying input to a native application to present modified output to a user of a gaming device, the method comprising:
detecting an activation of a native application; and
generating a modified input to the native application, the modified input corresponding to a gaming application executing on the gaming device, such that the modified input causes the native application to present a modified output via a user interface of the native application.

9. The method of claim 8, wherein the native application is selected from the group consisting of video viewfinder, digital camera, digital camcorder, audio recorder, audio player, video player, thermometer, global positioning system locator, radio receiver, mobile telephone, text messaging, push-to-talk communication, clock, decibel meter, barometer, altimeter, movement sensor, light sensor, and compass.

10. The method of claim 8, wherein generating the modified input comprises one of modifying or replacing a standard input from a native device to the native application.

11. The method of claim 8, wherein detecting the activation of the native application comprises detecting the activation of the native application by the user of the gaming device.

12. The method of claim 11, wherein detecting the activation of the native application comprises detecting the activation of the native application via a user input element of the gaming device.

13. The method of claim 8, wherein detecting the activation of the native application comprises detecting the activation of the native application by an event internal to the gaming device.

14. The method of claim 8, wherein the native application presents the modified output via an output element of the gaming device, the output element selected from the group consisting of audio speaker and video display.

15. A computer program product for modifying input to a native application to present modified output to a user of a gaming device, the computer program product comprising at least one computer-readable storage medium having computer-readable program code portions stored therein, the computer-readable program code portions comprising:
a first executable portion capable of detecting an activation of a native application; and
a second executable portion capable of generating a modified input to the native application, the modified input corresponding to a gaming application executing on the gaming device, such that the modified input causes the native application to present a modified output via a user interface of the native application.

16. The computer program product of claim 15, wherein the native application is selected from the group consisting of video viewfinder, digital camera, digital camcorder, audio recorder, audio player, video player, thermometer, global positioning system locator, radio receiver, mobile telephone, text messaging, push-to-talk communication, clock, decibel meter, barometer, altimeter, movement sensor, light sensor, and compass.

17. The computer program product of claim 15, wherein the second executable portion generates the modified input by one of modifying or replacing a standard input from a native device to the native application.

18. The computer program product of claim 15, wherein the first executable portion detects the activation of the native application by detecting the activation of the native application by the user of the gaming device.

19. The computer program product of claim 18, wherein the first executable portion detects the activation of the native application by detecting the activation of the native application via a user input element of the gaming device.

20. The computer program product of claim 15, wherein the first executable portion detects the activation of the native application by detecting the activation of the native application by an event internal to the gaming device.

21. The computer program product of claim 15, wherein the native application presents the modified output via an output element of the gaming device, the output element selected from the group consisting of audio speaker and video display.
